(19) United States
(12) Patent Application Publication
(10) Pub. No.: US 2009/0301048 A1
(43) Pub. Date: Dec. 10, 2009

(54) Filter for Removing Particles from a Gas Stream and Method for its Manufacture

(76) Inventors: Joerg Jockel, Ceske Budejovice (CZ); Matthias Kruse, Stuttgart-Vaihingen (DE); Bernd Reinsch, Ludwigsburg (DE); Andreas Mattern, Karlsruhe (DE); Christoph Saffe, Weil Der Stadt (DE); Lars Thuener, Royal Oak, MI (US)

Correspondence Address: KENYON & KENYON LLP, ONE BROADWAY, NEW YORK, NY, 10004, US

(21) Appl. No.: 12/227,456

(22) PCT Filed: Apr. 11, 2007
(86) PCT No.: PCT/EP2007/053510

§ 371 Date: Mar. 26, 2009

(30) Foreign Application Priority Data
Jun. 9, 2006 (DE) 102006026769.9

(51) Int. Cl. B01D 39/20; B05D 5/00

(52) U.S. Cl. 55/523; 427/244

(57) ABSTRACT

A filter for removing particles from a gas stream has a filter pad with a coating which contains at least one of the following substances: (a) at least one aluminum oxide selected from alpha-, gamma-, delta- and theta-aluminum oxide, (b) hydrous aluminum oxide which is doped with silicon dioxide, at least one oxide of a metal of the 3^{rd} to 5^{th} B group, at least one oxide of a lanthanoid including lanthanum or a mixture of one or more of these oxides, (c) silicon dioxide or silicon-rich zeolite or (d) titanium dioxide which is doped with at least one oxide of a metal of the 3^{rd} to 6^{th} B group or an oxide of a lanthanoid including lanthanum, (e) a mixture of zirconium dioxide with at least one oxide of a metal of the 3^{rd} to 5^{th} B group, at least one oxide of a lanthanoid including lanthanum or a mixture of one or more of these oxides.

### BACKGROUND OF THE INVENTION

1. Field of the Invention

The present invention relates to a filter for removing particles from a gas stream, especially soot particles from an exhaust gas stream of an internal combustion engine.

2. Description of Related Art

Such filters are used, for example, in the aftertreatment of the exhaust gas of self-igniting internal combustion engines, particularly in Diesel-driven motor vehicles. Usually, such filters for removing particles, so-called particulate filters, are made of the ceramic materials silicon carbide, aluminum titanate and/or cordierite. The particulate filters are generally developed in the form of a honeycomb-shaped ceramic having alternately closed channels. Such particulate filters have a filtration efficiency of more than 80% to regularly greater than 90%. However, the difficulty is not only in the filtration of the soot particles, but also in the regeneration of the filter. For this purpose, fuel or its decomposition products are catalytically oxidized in an exhaust-gas aftertreatment system which includes the particulate filter, in order to generate the temperatures required to ignite the soot. During the hottest regeneration phases, the greatest demands are made on the thermal stability of the filter.

Thermochemical reactions of the filter material with exhaust gas components and ashes collecting on the filter during operation over the service life of the motor vehicle, for instance, consisting of oil, fuel, fuel additives or abraded matter from the engine, reduce the mechanical and thermochemical stability of ceramic filters. Filters aged by thermochemical reaction have a higher probability of failure than non-aged filters, particularly if they are made of the substances cordierite and aluminum titanate. The probability of failure increases with high thermal stress.

Particulate filters are usually used these days whose ceramic filter substrate is uncoated, or furnished only with a catalytically active coating.

### BRIEF SUMMARY OF THE INVENTION

A filter developed according to the present invention, for removing particles from a gas stream, particularly of soot particles from an exhaust-gas stream of an internal combustion engine includes a filter member made of a ceramic filter substrate, the filter substrate being coated. The coating includes at least one of the following substances:

a) at least one aluminum oxide, selected from alpha-, gamma-, delta- and theta-aluminum oxide,
b) hydrous aluminum oxide, which is doped with silicon dioxide, at least one oxide of a metal of the 3^{rd} to 5^{th} B group, at least one oxide of a lanthanoid including lanthanum, or a mixture of one or more of these oxides,
c) silicon dioxide or silicon-rich zeolite,
d) titanium dioxide doped with at least one oxide of a metal of the 3^{rd} to 5^{th} B group or an oxide of a lanthanoid including lanthanum, or
e) a mixture of zirconium dioxide having at least one oxide of a metal of the 3^{rd} to 5^{th} B group, at least one oxide of a lanthanoid including lanthanum, or a mixture of one or more of these oxides.

A closed surface cover layer is generated by the coating, by which the ceramic filter material, especially aluminum titanate or cordierite, is protected from the thermochemical attack of exhaust gas components, especially ashes. This is possible because the ceramic cover layer according to the present invention resists the hydrothermal conditions during driving operation and during the regeneration, in a durable manner, that is, over the service life of the vehicle. The coating according to the present invention and the coating process according to the present invention are suitable for coating the entire surface of the filter, including the inner pore structure, as completely as possible.

A further increase in the thermal and hydrothermal stability of alpha, gamma, delta and theta aluminum oxide is achieved, for instance, by doping the aluminum oxide with at least one oxide of a metal of the 3^{rd} to 5^{th} B group or at least one oxide of a lanthanoid including lanthanum, or a mixture of a plurality of these oxides. The hydrothermal and thermal stability of hydrous aluminum oxide is also increased by doping with at least one of these oxides, so that an hydrous aluminum oxide, that is thus doped, is also suitable as a coating. The proportion of the oxide of a metal of the 3^{rd} to 5^{th} B group, of the oxide of a lanthanoid including lanthanum or a mixture of one or more of these oxides in the aluminum oxide or in the hydrous aluminum oxide is preferably in the range of 1 to 20 wt. %.

Preferably in powder form, the aluminum oxides suitable for forming the coating have a BET surface of more than 30 m²/g. The BET surface is determined by gas adsorption according to Brunauer, Emmet and Teller according to DIN 66131 and ISO 9277. The bulk density of the aluminum oxide is preferably greater than 0.3 g/cm³, and the pore volume is in a range of 0.2 to 1.3 ml/g. The doped aluminum oxides or mixtures of several aluminum oxides also have corresponding BET surfaces, bulk densities and pore volumes.

The thermal and hydrothermal stability of alpha, gamma, delta and theta aluminum oxide or hydrous aluminum oxide may also be increased by doping with silicon dioxide.

Moreover, a mixture of zirconium dioxide with one or more oxides of a metal of the 3^{rd} to 5^{th} B group, at least one oxide of a lanthanoid, including lanthanum, or a mixture of one or more of these oxides is suitable for the coating. The mixed oxides suitable for the formation of the coating, preferably in powder form, have a BET surface of more than 5 m²/g, the BET surface being determined as represented above.

Furthermore, silicon dioxide is also suitable for coating the filter substrate, in order to increase the thermal and hydrothermal stability. A further increase in the thermal and hydrothermal stability is achieved by admixing to the silicon oxide at least one oxide of a metal of the 3^{rd} to 5^{th} B group or at least one oxide of a lanthanoid including lanthanum or a mixture of several of these oxides. The proportion of each oxide of the metals of the 3^{rd} to 5^{th} B group or of the lanthanoids including lanthanum in the silicon oxide is preferably in the range of 1 to 30 wt. %.

For the coating, besides amorphous silicon dioxide in the form of particles, silicon-rich zeolites, especially having an S/A ratio greater than 50, particularly of type Y, β, ZSM or mixtures of these or with these are suitable for making up the coating. In this context, the zelites are preferably present in the H-form or having exchanged transition metals, particularly with elements of the 6^{th} to 12^{th} B group.

Besides the oxides named, titanium dioxide is also suitable for coating the ceramic filter substrate. A sufficient thermal and hydrothermal stability is achieved by admixing to the titanium dioxide at least one oxide of a metal of the 3^{rd} to 6^{th} B group or an oxide of a lanthanoid including lanthanum. The proportion of the at least one oxide of a metal of the 3 to 6 B group, of a lanthanoid including lanthanum or a mixture of one or more of these oxides preferably amounts to 1 to 60 wt. % per oxide. Tungsten oxide and vanadium oxide are particularly suitable for admixture to the titanium dioxide.

The possibly doped aluminum oxide, the doped hydrous aluminum oxide, the silicon dioxide or the silicon-rich zeolite, the titanium dioxide and the zirconium dioxide may be used in any desired mixture for coating the ceramic filter substrate.

The coating according to the present invention is preferably applied at the downstream or centrical area of the filter. As the downstream area, that side of the filter substrate is designated on which the gas purified of particles flows out. The middle region of the filter cross section is designated as the centrical region.

In addition, it is also possible to coat different regions of the filter with different materials or using different layer thicknesses.

To produce the coating according to the present invention, the coating material is applied, for instance, to the sintered ceramic filter substrate in the form of particles as a slurry or a sol, and is then fixed by drying, calcining or sintering. If the coating material is doped or contains admixtures, the doping, for instance in the form of solutions, may be added to the slurry during the production of the slurry or directly before coating the filter substrate. Furthermore, it is also possible for the doping to take place on preformed cover layers. To do this, the preformed cover layers are impregnated with the solutions of the doping substances. This is done, for example, by spraying, dipping, soaking or the like, processes known to one skilled in the art, by which a modified distribution of the doping on the surface is achieved.

The substances to be admixed may be admixed to the coating material that is to be doped, for instance, in the form of solid substances as oxide, hydroxide or salt, preferably carbonate, nitrate or acetate, or added as a sol.

The coating is also applied to the ceramic filter substrate, for example, in the form of particles as a slurry or as a sol by spraying, dipping, soaking or similar coating processes. Moreover, coating processes based on a vacuum are also suitable.

The average particle size (D 50) of the materials, suitable for the development of the coating, varies over a wide range. Particularly suitable are particles having a size of 2 nm to 20 μm. The particles may be obtained, for example, by precipitation processes or by pyrolytic processes. Grinding processes are also suitable for setting the particle size and the particle size distribution. If the particles are produced by a precipitation process, aluminum salt solutions and/or zirconium salt solutions, as well as possibly, as an addition, the salt solutions of the doping substances may be used as precursors.

Suitable cover layers are achieved, for example, by the combination of nanoparticles, that is, particles having an average diameter less than 1 μm, and microparticles, that is, particles having an average diameter greater than 1 μm, sometimes having bimodal or polymodal particle size distributions. Generally speaking, the proportion of the particles having an average diameter of more than 20 μm is less than 20 wt. %. The nanoparticles and the microparticles may be combined with one another both in one layer and in two or more successive layers.

Because of the particle size distribution of the particles with which the filter substrate is coated, and the rheological properties of the coating substance, the latter is suitable for covering the entire, even the inner filter substrate surface. Preferably so-called microcracks, that is, cracks within the individual crystallites of the filter substrate, are not coated.

The fixing of the ceramic cover layer on the filter substrate is performed, for instance, by drying, calcining and by sintering. By varying the quantity of the ceramic materials to be applied for the formation of the cover layer, the thickness of the cover layer may be varied. The degree of saturation of the filter with the ceramic materials for the coating is made with reference to the filter volume, and preferably amounts to between 0.61 g/l and 61 g/l, with respect to the entire filter volume.

### BRIEF DESCRIPTION OF THE SEVERAL VIEWS OF THE DRAWING

FIG. 1 shows a schematic representation of an internal combustion engine having an exhaust gas aftertreatment device according to the present invention.

FIG. 2 shows a filter element according to the present invention, in longitudinal section.

FIG. 3 shows a schematic representation of the coated filter substrate.

### DETAILED DESCRIPTION OF THE INVENTION

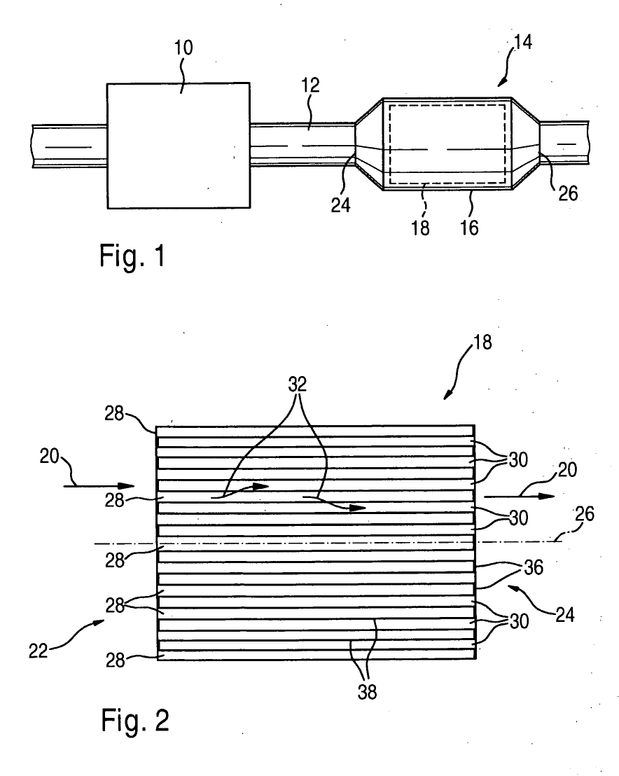

FIG. 1 shows a schematic representation of an internal combustion engine having an exhaust gas aftertreatment device according to the present invention. The exhaust gas aftertreatment device is a filter, in this case, in which soot particles are removed from the exhaust gas stream.

An internal combustion engine 10 is connected via an exhaust pipe 12 in which a filtering device 14 is situated. Soot particles are filtered out of the exhaust gas flowing in exhaust pipe 12, using filtering device 14. This is required in particular in the case of Diesel gasoline engines, in order to comply with legal provisions.

Filtering device 14 includes a cylindrical housing 16 in which a filter structure 18 is disposed, which in the present exemplary embodiment is rotationally symmetrical, and altogether also cylindrical.

FIG. 2 shows a filter element according to the present invention, in longitudinal section.

Filter element 18 is made, for instance, as an extruded molded article of a ceramic material such as magnesium aluminum silicate, preferably cordierite. Exhaust gas flows through filter element 18 in the direction of arrows 20. The exhaust gas enters filter element 18 via an inlet area 22 and leaves it via an outlet area 24.

A plurality of inlet channels 28 extends in parallel with a longitudinal axis 26 of filter element 18, alternating with outlet channels 30. Inlet channels 28 are sealed at exit area 24. In the specific embodiment shown here, closing stoppers 36 are provided for this. However, instead of closing stoppers 36, it is also possible to have inlet channels 28 taper in the direction towards outlet area 24, until the wall of inlet channel 28 will touch and inlet channel 28 will thus become closed. In this case, inlet channel 28 has a triangular cross section in the direction parallel with longitudinal axis 26.

Correspondingly, outlet channels 30 are open at outlet area 24 and closed in the region of inlet area 22.

The flow path of the unpurified exhaust gas thus leads into one of inlet channels 28 and from there, through a filter wall 38 into one of outlet channels 30. This is shown by way of example by arrows 32.

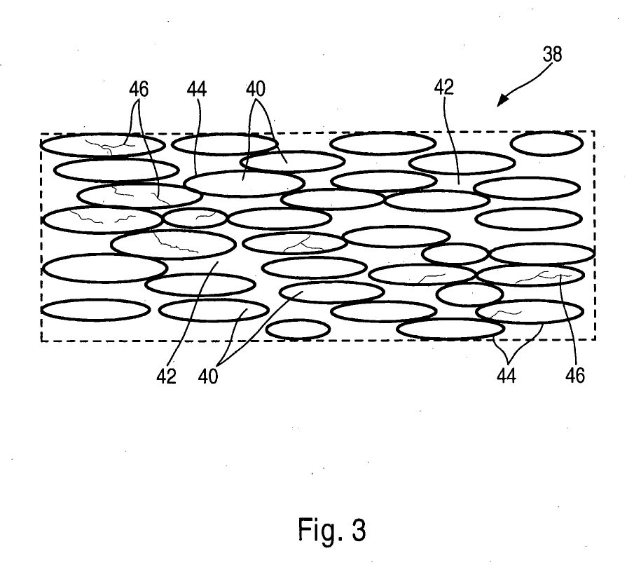

FIG. 3 shows a schematic representation of the coated filter substrate. A filter wall 38 is made of a ceramic filter substrate. The ceramic filter substrate is made of individual crystallites 40, which are generally connected to one another by sintering. The ceramic filter substrate is preferably silicon carbide, aluminum titanate or cordierite. Mixtures of these materials may also be used. Between individual crystallites 40 of the ceramic filter substrate there are pores 42, which have the gas stream flowing through it that is to be treated. Particles contained in the gas stream are retained by the ceramic filter substrate of filter wall 38. The particles that are removed from the gas stream also settle in pores 42. The free cross section in filter wall 38 is thereby decreased, and the pressure loss increases over filter wall 38. For this reason it is necessary to remove the particles from the pores at regular intervals. This is generally done by thermal regeneration, by heating the filter to a temperature of more than 600° C. At this temperature, the particles, that are usually organic, burn to form carbon dioxide and water, and are discharged from the particulate filter in gaseous form.

Since the filter substrate made of silicon carbide, aluminum titanate and/or cordierite is generally not permanently stable to these high temperatures, individual crystallites 40 are provided with a coating 44, according to the present invention. Coating 44 is preferably a ceramic coating which is stable to the high temperatures that occur during the regeneration of the particulate filter. As was described before, suitable coating materials are, for example, aluminum oxide possibly doped with an oxide of a metal of the 3^{rd} to 5^{th} B group, of a lanthanoid including lanthanum or of a mixture of one or more of these oxides, hydrous aluminum oxide which is doped with silicon dioxide, at least one oxide of a metal of the 3^{rd} to 5^{th} B group, at least one oxide of a lanthanoid including lanthanum or of a mixture of one or more of these oxides, possibly a silicon dioxide or a silicon-rich zeolite mixed with an oxide of a metal of the 3^{rd} to 5^{th} B group, of a lanthanoid including lanthanum or of a mixture of several of these oxides, titanium dioxide doped with an oxide of a metal of the 3^{rd} to 5^{th} B group, of a lanthanoid including lanthanum, a mixture of zirconium dioxide with at least one oxide of a metal of the 3^{rd} to 5^{th} B group, of at least one oxide of a lanthanoid including lanthanum or of a mixture of one or more of these oxides, or a mixture of a plurality of the above-named ceramic materials.

The coating 44 according to the present invention is suitable for being combined with an additional, possibly catalytically active coating.

Since the coating material is applied to the sintered ceramic substrate, generally in the form of particles, as a slurry or a sol, and is subsequently fixed by drying, calcining or sintering, the surfaces of crystallites 40 of the filter substrate of filter wall 38 are coated, including the walls of pores 42. The coating material preferably does not penetrate microcracks 46 that may possibly be included in crystallites 40. Coating of the microcracks is able to lower the stability of the filter.

1-13. (canceled)

14. A filter for removing particles from a gas stream, comprising:
a filter pad made of a ceramic filter substrate and a coating which coats the filter substrate, wherein the coating contains at least one of the following substances:
(a) at least one aluminum oxide, selected from alpha-, gamma-, delta- and theta-aluminum oxide;
(b) hydrous aluminum oxide doped with at least one of (i) silicon dioxide, (ii) at least one oxide of a metal of the 3rd to 5th B group, and (iii) at least one oxide of a lanthanoid including lanthanum;
(c) one of a silicon dioxide or a silicon-rich zeolite;
(d) titanium dioxide doped with (i) at least one oxide of a metal of the 3rd to 6th B group or (ii) an oxide of a lanthanoid including lanthanum; and
(e) a mixture including zirconium dioxide, at least one oxide of a metal of the 3rd to 5th B group, and at least one oxide of a lanthanoid including lanthanum.

15. The filter as recited in claim 14, wherein the aluminum oxide of the coating is doped with at least one of (i) an oxide of a metal of the 3rd to 5th B group, and (ii) an oxide of a lanthanoid including lanthanum.

16. The filter as recited in claim 15, wherein the proportion of the at least one of (i) an oxide of a metal of the 3rd to 5th B group, and (ii) an oxide of a lanthanoid including lanthanum in the aluminum oxide of the coating is in the range of 1 to 20 wt %.

17. The filter as recited in claim 14, wherein the silicon oxide material is doped with at least one of (i) an oxide of a metal of the 3rd to 5th B group, and (ii) an oxide of a lanthanoid including lanthanum.

18. The filter as recited in claim 17, wherein the proportion of the at least one of (i) an oxide of a metal of the 3rd to 5th B group, and (ii) an oxide of a lanthanoid including lanthanum in the silicon dioxide is in the range of 1 to 30 wt %.

19. The filter as recited in claim 14, wherein the titanium dioxide is doped with an oxide of one of vanadium or tungsten.

20. The filter as recited in claim 14, wherein the silicon-rich zeolite is present in one of (i) H-form or (ii) having exchanged transition metal.

21. The filter as recited in claim 14, wherein in the mixture (e), the proportion of each one of (i) the at least one oxide of a metal of the 3rd to 5th B group, and (ii) at least one oxide of a lanthanoid including lanthanum is in the range of 1 to 60 wt %.

22. The filter as recited in claim 14, wherein the coating is applied in one of a downstream or centrical region of the filter.

23. A method for coating a filter for removing particles from a gas stream, comprising:
providing a filter pad made of a sintered ceramic filter substrate;
applying a coating material in the form of particles as a slurry or as a sol, onto the sintered ceramic filter substrate; and
fixing the applied coating to the filter substrate by one of drying, calcining or sintering;
wherein the coating contains at least one of the following substances:
(a) at least one aluminum oxide, selected from alpha-, gamma-, delta- and theta-aluminum oxide;
(b) hydrous aluminum oxide doped with at least one of (i) silicon dioxide, (ii) at least one oxide of a metal of the 3rd to 5th B group, and (iii) at least one oxide of a lanthanoid including lanthanum;
(c) one of a silicon dioxide or a silicon-rich zeolite;
(d) titanium dioxide doped with (i) at least one oxide of a metal of the 3rd to 6th B group or (ii) an oxide of a lanthanoid including lanthanum; and
(e) a mixture including zirconium dioxide, at least one oxide of a metal of the 3rd to 5th B group, and at least one oxide of a lanthanoid including lanthanum.

24. The method as recited in claim 23, wherein the particles contained in the slurry for the formation of the coating have a BET surface of more than 5 m²/g.

25. The method as recited in claim 24, wherein the particles contained in the slurry have an average particle diameter in the range of 2 nm to 20 μm.

26. The method as recited in claim 24, wherein the hydrous aluminum oxide and the silicon dioxide are present in the form of solids as one of (i) an oxide, (ii) a hydroxide, (c) a salt including carbonate, nitrate, or acetate, or (iv) a sol.
